(19) United States
(12) Patent Application Publication
(10) Pub. No.: US 2024/0241691 A1
(43) Pub. Date: Jul. 18, 2024

(54) ELECTRONIC DEVICE AND METHOD WITH DATA SCALING

(71) Applicant: SAMSUNG ELECTRONICS CO., LTD., Suwon-si (KR)

(72) Inventors: Chang-Woo SHIN, Suwon-si (KR); Soon-Wan KWON, Suwon-si (KR); Seijoon KIM, Suwon-si (KR); Hyunsoo KIM, Suwon-si (KR); Seungkeun YOON, Suwon-si (KR)

(73) Assignee: SAMSUNG ELECTRONICS CO., LTD., Suwon-si (KR)

(21) Appl. No.: 18/524,520

(22) Filed: Nov. 30, 2023

(30) Foreign Application Priority Data
Jan. 18, 2023 (KR) 10-2023-0007596

(51) Int. Cl. G06F 5/01

(52) U.S. Cl. CPC G06F 5/01

(57) ABSTRACT

An electronic device and method with data scaling is provided herein. The electronic device may include a computing device that includes an analog computing circuit, where the computing device may scale an input of the analog computing circuit using a first scaling factor and/or scale a weight of the analog computing circuit using a second scaling factor, where the input includes a plurality of input values within a preset input maximum range of values of the computing device, and the weight includes a plurality of weight values within a preset weight maximum range of values of the computing device, and rescale an output of the analog computing circuit based on the first scaling factor and/or the second scaling factor. The first and second scaling factors may respectively scale values of the input and the weight to exceed respective preset maximum ranges of values.

### CROSS-REFERENCE TO RELATED APPLICATIONS

This application claims the benefit under 35 USC § 119(a) of Korean Patent Application No. 10-2023-0007596, filed on Jan. 18, 2023, in the Korean Intellectual Property Office, the entire disclosure of which is incorporated herein by reference for all purposes.

### BACKGROUND

### 1. Field

The following description relates to an electronic device and method with data scaling.

### 2. Description of Related Art

An example of the complex computational operations respectively involved with the training and inference operations of machine learning models include matrix vector multiplication (MVM) operations that may involve many multiplication and accumulation (MAC) operations, such as when the machine learning model is a neural network model. In neural network models, such operations may require many operations that are repeated through the typical multi-layered structure of the neural network model, consuming substantial time, processing power, and energy resources. In the past, techniques such as minimizing data movement and efficient data reuse, lightening techniques such as pruning and quantization, have been used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes a computing device including an analog computing circuit, where the computing device is configured to scale an input of the analog computing circuit using a first scaling factor and/or scale a weight of the analog computing circuit using a second scaling factor, where the input includes a plurality of input values within a preset input maximum range of values of the computing device, and the weight includes a plurality of weight values within a preset weight maximum range of values of the computing device, and rescale an output of the analog computing circuit based on the first scaling factor and/or the second scaling factor, and where the first scaling factor is a factor that scales one or more values of the input to be outside the preset input maximum range of values and the second scaling factor is another factor that scales one or more values of the weight to be outside the preset weight maximum range of values of the computing device.

The first scaling factor may be same as a first input factor multiplied by a second input factor, the first input factor may be a first factor whose application of the first factor to the input scales a maximum input value, of the plurality of input values, to increase to a maximum value of the preset input maximum range of values, and/or that scales a minimum input value, of the plurality of input values, to decrease to a minimum value of the preset input maximum range of values, based on a distribution range of the input, and the second input factor may be a second factor whose application of the second factor to a first scaled input, resulting from the application of the first factor to the input, increases the scaled maximum input value of the first scaled input to be greater than the maximum value of the preset input maximum range of values, and/or that decreases the scaled minimum input value of the first scaled input to be less than the minimum value of the preset input maximum range of values.

The second scaling factor may be same as a third weight factor multiplied by a fourth weight factor, where the third weight factor may be a third factor whose application of the third factor to the weight scales a maximum weight value, of the plurality of weight values, to increase to a maximum value of the preset weight maximum range of values, and/or that scales a minimum weight value, of the plurality of weight values, to decrease to a minimum value of the preset weight maximum range of values, and based on a distribution range of the weight, and where the fourth weight factor may be a fourth factor whose application of the fourth factor to a first scaled weight, resulting from the application of the third factor to the weight, increases the scaled maximum weight value of the first scaled weight to be greater than the maximum value of the preset weight maximum range of values, and/or that decreases the scaled minimum weight value of the first scaled weight to be less than the minimum value of the preset weight maximum range of values.

The analog computing circuit may have a crossbar array structure with resistive elements.

The electronic device may further include a host processor configured to control the computing device, and the computing device may be disposed inside or outside the host processor.

The preset input maximum range of values may be same as the preset weight maximum range of values, and the analog computing circuit may be configured to perform analog computations based on the scaled input and the scaled weight to generate the output.

The computing device may include a plurality of analog computing circuits, including the analog computing circuit, each respectively arranged in a crossbar array structure with resistive elements configured to store corresponding weight values scaled according to a corresponding second scaling factor, and with each analog computing circuit being provided a respective scaled input according to a corresponding first scaling factor.

In one general aspect, a computing device includes a plurality of analog computing circuits, where the computing device is configured to scale respective inputs of each of the plurality of analog computing circuits using a corresponding input scaling factor, scale respective weights of each of the plurality of analog computing circuits using a corresponding weight scaling factor, and sum respective outputs of the plurality of analog computing circuits.

For each of the analog computing circuits, the corresponding input scaling factor may scale positive values of the respective input to increase to become greater than a preset input maximum range of values, and/or scale negative values of the respective input to decrease to become less than the preset input maximum range of values, and, for each of the analog computing circuits, the corresponding weight scaling factor may scale positive values of the respective weight to become greater than a preset weight maximum range of values, and/or scale negative values of the respective weight to decrease to become less than the preset weight maximum range of values.

The computing device may be configured to, for each of the analog computing circuits, scale the respective input using the corresponding input scaling factor, scale the respective weight using the corresponding weight scaling factor, and rescale a result of the summing of the respective outputs of the plurality of computing circuits based on the corresponding input scaling factor and the corresponding weight scaling factor.

The corresponding input scaling factors may each be same, and the corresponding weight scaling factors may each be same.

The input maximum range of values may be same as the preset weight maximum range of values, and the analog computing circuits may be respectively configured to perform corresponding analog computations based on the respective scaled inputs and the respective scaled weights.

Each of the corresponding input scaling factors may be determined for a corresponding one of the respective inputs, and each of the corresponding weight scaling factors may be determined for a corresponding one of the respective weights.

The computing device may be configured to, for each of the analog computing circuits, scale the respective input using the corresponding input scaling factor, scale the respective weight using the corresponding weight scaling factor, and rescale the respective output based on the corresponding input scaling factor and the corresponding weight scaling factor, and the computing device may be configured to sum the rescaled respective outputs.

Each of the plurality of analog computing circuits may have a crossbar array structure having respective resistive elements.

The electronic device may further include a host processor configured to control the computing device, and the computing device may be disposed inside or outside the host processor.

In one general aspect, a method of an electronic device, including an analog computing circuit, includes scaling an input of the analog computing circuit using a first scaling factor and/or scaling a weight of the analog computing circuit using a second scaling factor, where the input includes a plurality of input values within a preset input maximum range of values of the computing device, and the weight includes a plurality of weight values within a preset weight maximum range of values of the computing device, and rescaling an output of the analog computing circuit based on the first scaling factor and/or the second scaling factor, where the first scaling factor is a factor that scales one or more values of the input to be outside the preset input maximum range of values and the second scaling factor is another factor that scales one or more values of the weight to be outside the preset weight maximum range of values of the computing device.

The first scaling factor may be same as a first input factor multiplied by a second input factor, the first input factor may be a first factor whose application of the first factor to the input scales a maximum input value, of the plurality of input values, to increase to a maximum value of the preset input maximum range of values, and/or that scales a minimum input value, of the plurality of input values, to decrease to a minimum value of the preset input maximum range of values, based on a distribution range of the input, and the second input factor may be a second factor whose application of the second factor to a first scaled input, resulting from the application of the first factor to the input, increases the scaled maximum input value of the first scaled input to be greater than the maximum value of the preset input maximum range of values, and/or that decreases the scaled minimum input value of the first scaled input to be less than the minimum value of the preset input maximum range of values.

The second scaling factor may be same as a third weight factor multiplied by a fourth weight factor, the third weight factor may be a third whose application to the weight scales a maximum weight value, of the plurality of weight values, to increase to a maximum value of the preset weight maximum range of values, and/or that scales a minimum weight value, of the plurality of weight values, to decrease to a minimum value of the preset weight maximum range of values, and based on a distribution range of the weight, and the fourth weight factor may be a fourth factor whose application of the fourth factor to a first scaled weight, resulting from the application of the third factor to the weight, increases the scaled maximum weight value of the first scaled weight to be greater than the maximum value of the preset weight maximum range of values, and/or that decreases the scaled minimum weight value of the first scaled weight to be less than the minimum value of the preset weight maximum range of values.

The analog computing circuit may have a crossbar array structure with resistive elements.

Other features and aspects will be apparent from the following detailed description, the drawings, and the claims.

### BRIEF DESCRIPTION OF THE DRAWINGS

FIG. 1 illustrates an example electronic device, according to one or more embodiments.

FIG. 2 illustrates an example analog computing circuit, according to one or more embodiments.

FIG. 3 illustrates an example operational error due to quantization and noise.

FIGS. 4 to 6 illustrate example matrix vector multiplication (MVM) operations, according to various embodiments.

FIG. 7 illustrates example operations of an electronic device, according to one or more embodiments.

FIG. 8 illustrates example weight value probability distributions according to scaling factors, according to one or more embodiments.

FIG. 9 illustrates an example result of operations performed with a scaling factor, according to one or more embodiments.

FIGS. 10 to 12 illustrate example methods, according to various embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order (e.g., a certain order). Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement, means that at least one example or embodiment exists where such a feature is included or implemented) while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

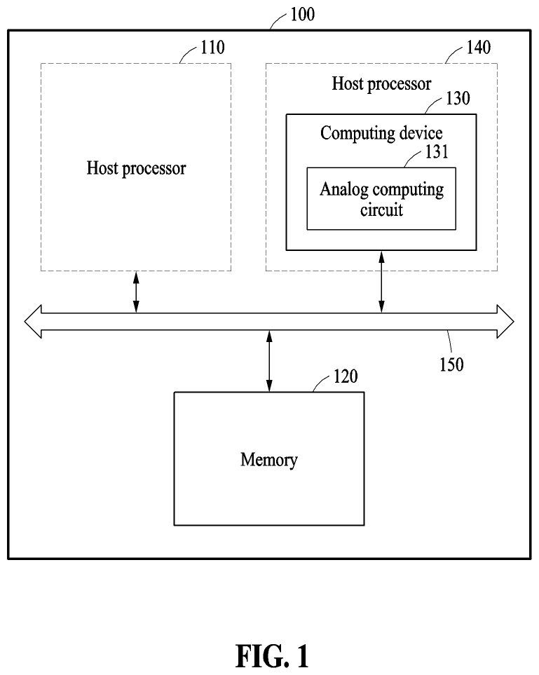

FIG. 1 illustrates an example electronic device, according to one or more embodiments.

Referring to FIG. 1, an electronic device 100 may include a computing device 130 and a memory 120. The computing device 130 may be in the form of a device included in the electronic device 100 separately from a host processor 110. Alternatively, the computing device 130 may be in a form included in a host processor 140.

The electronic device 100 may include the host processor 110. Here, the host processor 110, the memory 120, and the computing device 130 may communicate with each other through a communication system 150, representing one or more of a bus, a network on a chip (NoC), a peripheral component interconnect express (PCIe), or the like. In the electronic device 100 shown in FIG. 1, while some components of the electronic device 100 are illustrated, the electronic device 100 may also include other general-purpose components, in addition to the components illustrated in FIG. 1.

The host processor 110 may perform operations of controlling the electronic device 100 overall. The host processor 110 may control the electronic device 100 overall by executing instructions (e.g., computer/processor readable/executable instructions, programs, or other coding) stored in the memory 120. The host processor 110 may control the computing device 130. The host processor 110 is representative of one or more of each of a central processing unit (CPU), a graphics processing unit (GPU), an application processor (AP), and the like, that are included in the electronic device 100, though examples are not limited thereto.

The memory 120 may be hardware for storing data processed by the electronic device 100 and data to be processed. In addition, the memory 120 may store an application, a driver, and the like to be driven by the electronic device 100. The memory 120 may include a volatile memory (e.g., dynamic random-access memory (DRAM)) and/or a nonvolatile memory.

The electronic device 100 may include the computing device 130. The computing device 130 may process tasks that are processed by a separate dedicated processor, for example, the computing device 130, rather than by the host processor 110, which may be used for general purposes based on characteristics of operations. Here, at least one processing element (PE) in the computing device 130 may be utilized. The computing device 130 may include an analog computing circuit 131 that performs an analog operation. The computing device 130 may be a processor-in-memory (PIM) or other in-memory computing device using the analog computing circuit 131, as a non-limiting example. Specifically, the computing device 130 may be a device that performs a matrix vector multiplication (MVM) operation using processor-in-memory (PIM) or other in-memory computing method using the analog computing circuit 131, as a non-limiting example. The analog computing circuit 131 may have a crossbar array structure including a resistive element.

The electronic device 100 may include the host processor 140 and the host processor 140 may include the computing device 130.

In an example, the host processor 140 may have a same or like configuration as the host processor 110, except that the host processor 140 may further include one or more computing devices 130, each of which may include one or more computing circuits 131. Accordingly, the description above with respect to the host processor 110 is also applicable to the host processor 140. The computing device 130 may be in the form of a processor-in- memory or processing block in the host processor 140. One or more or any combination of the operations described below may be performed by the computing device 130, but examples are not limited thereto.

For example, the computing device 130 may scale an input of the analog computing circuit 131. The computing device 130 may scale a weight of the analog computing circuit 131. The analog computing circuit 131 may perform an MVM operation based on a multiplication and accumulation (MAC) operation using the scaled input and the scaled weight. The computing device 130 may rescale an output of the analog computing circuit 131. Through the above-described operation, it is possible to reduce the effect of noise and operational errors due to quantization.

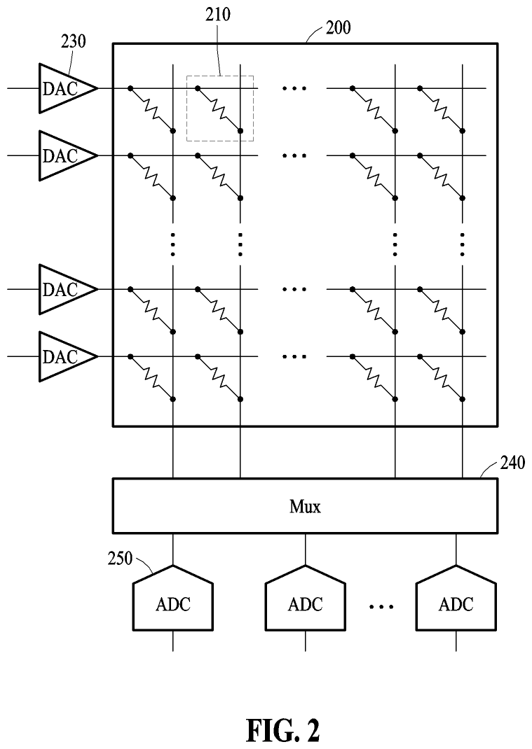

FIG. 2 illustrates an example analog computing circuit, according to one or more embodiments.

Referring to FIG. 2, an analog computing circuit 200 may include multiple resistive elements 210. Specifically, the analog computing circuit 200 may have a crossbar array structure. In the crossbar array structure, the resistive element 210 may be disposed at each point of the crossbar. Here, a resistance value of the resistive element 210 may represent a component value of a weight in an MVM operation. The analog computing circuit 200 may have a crossbar array structure and may perform an MVM operation using an in-memory computing method. Magnetic random access memory (MRAM), phase-change random access memory (PRAM), and resistive random access memory (RRAM) may be used as the resistive element 210.

Referring to FIG. 2, digital-to-analog converter(s) (DAC) 230 may convert a digital signal into an analog signal to be input to the analog computing circuit 200. In addition, analog- to-digital converter(s) (ADCs) 250 may convert an analog signal that is an output of the analog computing circuit 200 into a digital signal. In an example, a multiplexer (Mux) 240 may be disposed between the analog computing circuit 200 and the ADCs 250. In an example, the DACs 230 and/or the ADCs 250 of FIG. 2 maybe portions of the analog computing circuit 200.

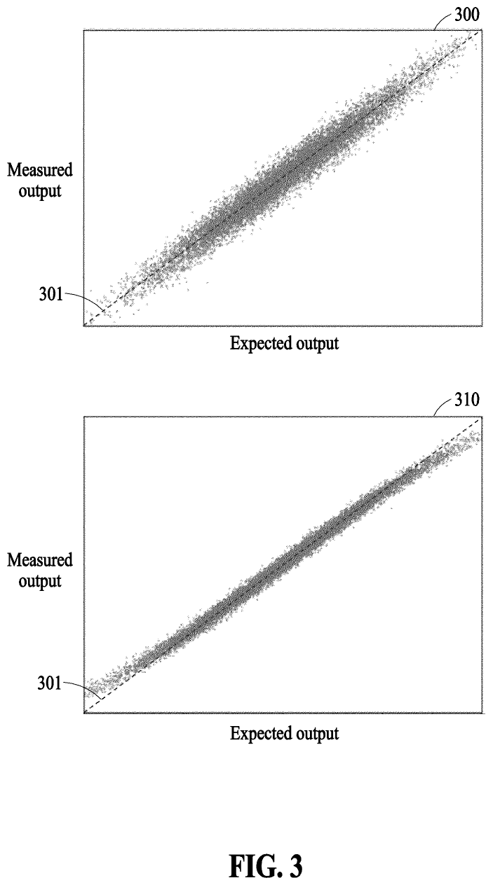

FIG. 3 illustrates an example operational error due to quantization and noise.

In various embodiments, computing devices that performs an MVM operation may include an analog computing circuit (e.g., which may include a crossbar array structure including resistive elements), as a non-limiting example.

Typically, such crossbar array structures may have low operational precision compared to a general computing device. Thus, it may be difficult to implement the high precision machine learning model with such a crossbar array structure, especially because high accuracies of the machine learning model may have been obtained for implementing the machine learning model at the high (full) precision by the general computing device. For example, while parameters of such a high precision machine learning model may be converted to low precision parameters, additional training is typically required for the converted low precision machine learning model to have an adequate lower accuracy.

The low operational precision of the crossbar array structure may be due to a quantization error due to low precision of an input and a weight, non-uniformity of a resistive element, noise due to an analog operation, and quantization and noise of an ADC (e.g., the ADCs 250 of FIG. 2).

Referring to FIG. 3, a graph shows a measured output versus an expected output of a machine learning model.

As the measured output is almost linear 301 with the expected output, operational precision may increase. Here, as demonstrated by a graph 300, the measured output spreads to some extent in the middle, and accordingly, an operational error may occur.

Referring to a graph 310, although the measured output appears to be slightly linear in the middle, an operational error may occur at both ends of the graph 310.

In the graphs 300 and 310, the corresponding operational error may be caused by noise and a quantization error generated in the computing device.

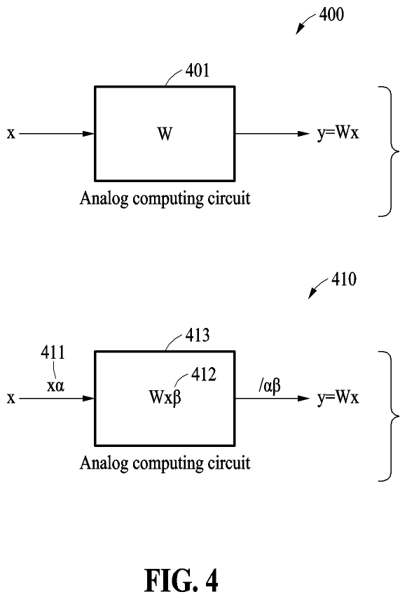

FIGS. 4 to 6 illustrate example MVM operations of an electronic device, according to various embodiments.

Referring to operation 400, an analog computing circuit 401 may have a weight W as a parameter. Including multiple weight values (as respective parameters), the weight W may be organized with more than one dimension, i.e., more than one dimensional vector of weight values. The weight W may be a weight of a trained machine learning model.

The analog computing circuit 401 may perform a general MVM operation with the weight W when an input x (representative of multiple different input values) is input. Therefore, the analog computing circuit 410 may output y=Wx as an output. For example, the analog computing circuit 401 may perform a MAC operation (i.e., yⱼ=ΣWⱼᵢ⋅xᵢ) as a basic unit operation.

The analog computing circuit 401 may have a crossbar array structure including a resistive element, and may be utilized with scaled inputs and weights that may result in increased performance and reduction of operational errors. Rather, due to a feature of a typical crossbar array structure, an operational error (e.g., due to noise and quantization error) may otherwise typically occur as described with reference to FIG. 3 (e.g., the typical implementation of the crossbar array structure may reduce performance of a machine learning model). For example, such noise and/or error may be due to potential non-uniformities of the resistive elements of an example crossbar array structure of the analog computing circuit 401, noise due to the analog operations of the crossbar array structure of the analog computing circuit 401, noise of DACs of the corresponding analog computing circuit 401 or the corresponding typical computing device, or quantization and other noise of ADCs of the analog computing circuit 401 or the corresponding typical computing device, as non-limiting examples. The noise and/or error may also be other quantization error, such as in examples where a corresponding input and/or weight of a high precision machine learning model is converted (e.g., quantized) to a low precision input and/or weight before being input to the computing device or scaled for/when input to analog computing circuit 401.

Referring to operation 410, the input x may be scaled using a first scaling factor 411. The weight W may be scaled using a second scaling factor 412. An analog computing circuit 413 (e.g., the analog computing circuit 200 of FIG. 2) may perform an MVM operation using the input x and the weight W respectively scaled by the first scaling factor 411 and the second scaling factor 412. An output of the analog computing circuit 413 may be rescaled using the first scaling factor 411 and the second scaling factor 412. Here, the first scaling factor 411 may represent a scaling factor applied to the input x that is input to the analog computing circuit 413 and the second scaling factor 412 may represent a scaling factor applied to the weight W of the analog computing circuit 413.

Therefore, by scaling the input x and the weight W and rescaling the output, a same resultant MVM operation value may be output in an ideal case without a quantization error or noise. That is, by increasing a range of output values of the analog computing circuit 413, an operational result robust against an error and/or noise may be obtained. For example, noise and/or error related to the analog computing circuit 413 (e.g., due to potential non-uniformities of the resistive elements of the analog computing circuit 413, noise and/or error due to other analog operations of the analog computing circuit 413, noise and/or error with respect to the input x due to DACs, such as the DACs 230 of FIG. 2, of the analog computing circuit 413 or the corresponding computing device that includes the analog computing circuit 413, and/or quantization error (and/or other error) and/or noise of ADCs, such as the ADCs 250 of FIG. 2, of the analog computing circuit 413 or the corresponding computing device that includes the analog computing circuit 413) may be reduced by increasing the range of all or most of the input values of input x and/or weight values of weight W and performing the analog operations on the scaled input values of the input x and/or scaled weight values of the weight W. Then, by rescaling the output of the analog computing circuit 413 (e.g., by dividing the output by the first scaling factor 11 and the second scaling factor 412), the ‘scale’ of the output will conform with trained ‘scale’ of the result of the corresponding MVM operation of the trained machine learning model (e.g., the ‘scale’ of the output of a corresponding high-precision of the MVM operation of the trained machine learning model if the high-precision of the MVM operation were performed by a general purpose processor, a graphics processor, or an neural accelerator). In an example, any quantization of the input x or the weight W (e.g., respectively from high precision inputs or weights to low precision inputs or weights) are performed before either of any respective first factor (normalization) scaling and third factor (normalization) scaling, as described herein, and before any first scaling factor scaling, second scaling factor scaling, and optimization factor scaling described herein. Thus, in such an example, the magnitude scaling of the normalization factor and the magnitude scaling of the optimization factor are both not quantization operations.

The first scaling factor 411 may be a product of a first factor (for performing the first factor normalization scaling) and a second factor. The first factor may increase the magnitudes of the input values of the input x based on a distribution range of the input values of the input x that are input to the analog computing circuit 413. There may be predetermined maximum (positive and/or negative maximums) values available or permitted for each input value of the input x with respect to the analog computing circuit 413 (hereinafter referred to as a preset input maximum range of values). In an example, the preset input maximum range of values may correspond to noise and/or error generating characteristics of the analog computing circuit 413 (or the analog computing circuit 413 in combination with either or both of the DACs (e.g., the DACs 230 of FIG. 2) disposed in or before the analog computing circuit 413 and/or ADCs (e.g., the ADCs 250 of FIG. 2) disposed in or after the analog computing circuit 413). For example, the noise and/or error generating characteristics may be one or more clipping thresholds (e.g., the respective positive and negative magnitudes just before or at maximum magnitude thresholds after which greater magnitudes are clipped). For example, the clipping threshold may be based on voltage and/or current limits of the bit lines and/or bit columns of the example crossbar array structure of the analog computing circuit 413, voltage and/or current limits of the resistive elements of the example crossbar configuration of the analog computing circuit 413, clipping thresholds of the DACs, and/or clipping thresholds of the ADCs. Thus, the first factor may increase the magnitudes of the input values of the input x to be maximum (normalized) in the preset input maximum range of values. In an example, the input x (e.g., at least some input values of the input x) may already be greater than the preset input maximum range of values, in which case the first factor may be a factor that reduces the magnitude of the input x to be maximum (normalized) within the preset input maximum range of values, i.e., the first factor may be set so a maximum positive (and maximum negative if applicable) input value of the input x will scaled by the application of the first factor to become values at or near the maximum positive (and maximum negative if applicable) values of the preset input maximum range of values.

For example, when a distribution range of the input x that is input to the analog computing circuit 413 is −0.8 to +0.7 and the preset input maximum range of values is −8 to +7, represented in 4 bits, the first factor may be “10” as a value that maximizes (normalizes) the magnitude of the input x in the preset input maximum range of values, i.e., the maximum positive value +0.7 will be increased to now have a scaled value of +7, the maximum negative value −0.8 will be decreased to now have a scaled value of −8, and the input values between −0.8 and +0.7 will now have values between −8 and +7 respectively based on the example first factor of “10”.

Accordingly, the first factor may be determined based on the distribution range of the input x. Here, the first factor may be a normalization factor that normalizes the size of the input x.

The second factor may be a factor that increases the magnitude of the first factor scaled input x, i.e., having magnitudes that have already been increased or decreased by the first factor, to have magnitudes that exceed the preset input maximum range of values.

For example, when the input x is correspondingly maximized (normalized) in the preset input maximum range of values by the first factor (e.g., to have the original input values' magnitudes increased or decreased to be within the preset input maximum range of values of −8 to +7), the second factor may further increase magnitudes of values of the first factor scaled input x to exceed the preset input maximum range of values. For example, if the second factor is “2”, the magnitude of each value of the already scale 3d first factor scaled input x may be proportionally increased according to the second factor, in which case a maximum positive input value of the first factor scaled input x may be scaled by multiplying this input value +7 by the second factor, to now have a value of +14. Similarly, with this example second factor of “2”, the minimum negative input value of the first factor scaled input x may be −8 and may be scaled by multiplying this input value −8 by the fourth factor, to now have a value of −16, and a middle positive input value of the first factor scaled input x may be +3 and may be scaled by multiplying this already scaled input value +3 by the second factor, to now have a value of +6.

Here, a product of the first factor and the second factor may be the optimization factor for the input x that optimizes the scaled magnitudes of the input x. Accordingly, the first scaling factor 411 may be determined as the optimization factor that is the product of the first factor and the second factor, for increasing magnitudes of the values of the input x to exceed (be outside of, e.g., in respective negative and positive directions) the preset input maximum range of values.

Similarly, the second scaling factor 412 may be a product of a third factor and a fourth factor. The third factor may increase the magnitudes of the weight values of the weight W based on a distribution range of the weight values of the weight W. There may be predetermined maximum values (positive and/or negative maximums) available or permitted for each weight value of the weight W with respect to the analog computing circuit 413 (hereinafter referred to as a preset weight maximum range of values). In an example, the preset weight maximum range of values may correspond to noise and/or error generating characteristics of the analog computing circuit 413 (or the analog computing circuit 413 in combination with ADCs (e.g., the ADCs 250 of FIG. 2) disposed after the analog computing circuit 413). For example, the noise and/or error generating characteristics may be one or more clipping thresholds (e.g., the respective positive and negative magnitudes just before or at maximum magnitude thresholds after which greater magnitudes are clipped). For example, the clipping threshold may be based on voltage and/or current limits of the bit lines and/or bit columns of the example crossbar array structure of the analog computing circuit 413, voltage and/or current limits of the resistive elements of the example crossbar configuration of the analog computing circuit 413, and/or clipping thresholds of the ADCs. Thus, the third factor may increase the magnitudes of the weight values of the weight W to be maximum (normalized) in the preset weight maximum range of values. In an example, weight W (e.g., at least some weight values of the weight W) may already exceed the preset weight maximum range of values, in which case the third factor may be a factor that decreases the magnitude of the weight W to be maximum (normalized) within the preset weight maximum range of values, i.e., the third factor may be set so maximum positive (and maximum negative if applicable) weight values of the weight W will be scaled by the application of the third factor to become at or near the maximum positive (and maximum negative if applicable) values of the preset weight maximum range of values.

For example, when a distribution range of the weight W of the analog computing circuit 413 is −4 to +3.5 and the preset weight maximum range of values is -8 to +7, represented as 4 bits, the third factor may be “2” as a value that maximizes (normalizes) the magnitude of the weight W in the preset weight maximum range of values, i.e., the maximum positive value +3.5 will now have a scaled value of +7, the maximum negative value −4 will now have a scaled value of −8, and the weight values between -4 and +3.5 will now have values between −8 and +7 respectively based on the example third factor of “2”.

Accordingly, the third factor may be determined based on the distribution range of the weights W. Here, the third factor may be a normalization factor that normalizes the weight W.

The fourth factor may be a factor that increases the magnitude of the third factor scaled weight W, i.e., having magnitudes that have already been increased or decreased by the third factor, to have magnitudes that exceed the preset weight maximum range of values.

For example, when the weight W is correspondingly maximized (normalized) in the preset weight maximum range of values by the third factor (e.g., to have the original weight values' magnitudes increased or decreased to be within the preset weight maximum range of values of −8 to +7), the fourth factor may further respectively increase magnitudes of the third factor scaled weight W to exceed the preset weight maximum range of values. For example, if the fourth factor is “3”, the magnitude of each value of the already scaled third factor scaled weight W may be proportionally increased according to the fourth factor, in which case a maximum positive weight value of the third factor scaled weight W may be scaled by multiplying the weight value +7 by the fourth factor, to now have a value of +21. Similarly, with this example fourth factor of “3”, the minimum negative weight value of the third factor scaled weight W may be −8 and may be scaled by multiplying the weight value −8 by the fourth factor, to now have a value of −24, and a middle positive weight value of the third factor scaled weight W may be an already scaled +3 and may be further by multiplying the already scaled weight value +3 by the fourth factor, to now have a value of +9.

Here, a product of the third factor and the fourth factor may be the optimization factor for the weight W that optimizes the magnitudes of the weight W. Accordingly, the second scaling factor 412 may be determined as the optimization factor that is the product of the third factor and the fourth factor, for increasing magnitudes of the weight values of the weight W to exceed (be outside of, e.g., in respective negative and positive directions) the preset weight maximum range of values. The output of the analog computing circuit 413 may be rescaled by dividing the output by first scaling factor 411 and the second scaling factor 412.

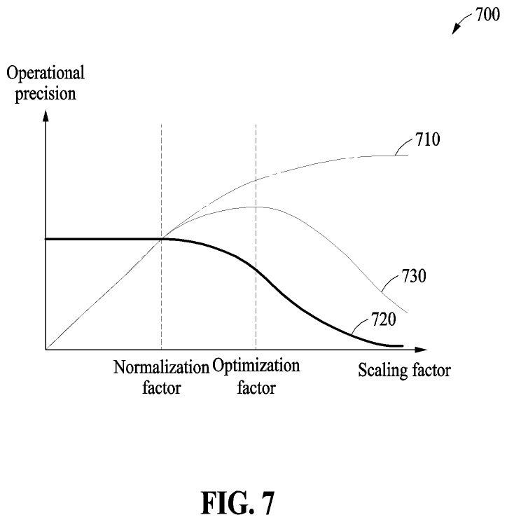

The first factor and the third factor may be determined in a training process of a machine learning model. That is, the normalization factor may be determined in the training process of the machine learning model. The second factor and the fourth factor may be determined in an inference process of the machine learning model. That is, the optimization factor may be determined in the inference process of the machine learning model. For example, the optimization factor may be determined during an inference operation based on the underlying architecture of the computing device, e.g., the underlying architecture of the analog computing circuit, such as by generating the graph 700 of FIG. 7 to observe or determine the optimization factor, such as when the machine learning model was trained as a high precision machine learning model with respect to a general purpose processor, a graphics processor, or a neural accelerator.

In an example, all of the first factor (normalization factor) and the second factor, of the corresponding input optimization factor, and the third factor (normalization factor) and the fourth factor, of the corresponding weight optimization factor, may be determined in the training process of the machine learning model. That is, both the normalization factor and the optimization factor for each of an input and the weight W may be determined in the training process of the machine learning model.

For example, when the optimization factors are determined during training, the optimization factors for the input x and the weight W may be stored as respective hyperparameters along with other parameters (e.g., the trained weight values and bias values) of the machine learning model. For example, the memory 120 of the electronic device 100 of FIG. 1 may store all types of parameters for various machine learning models described herein, including any of the neural network models described herein. In an example, each optimization factor may be determined as a value at which respective operational precision of the analog computing circuit is the highest through a change of a corresponding value, such as discussed below with respect to FIG. 7.

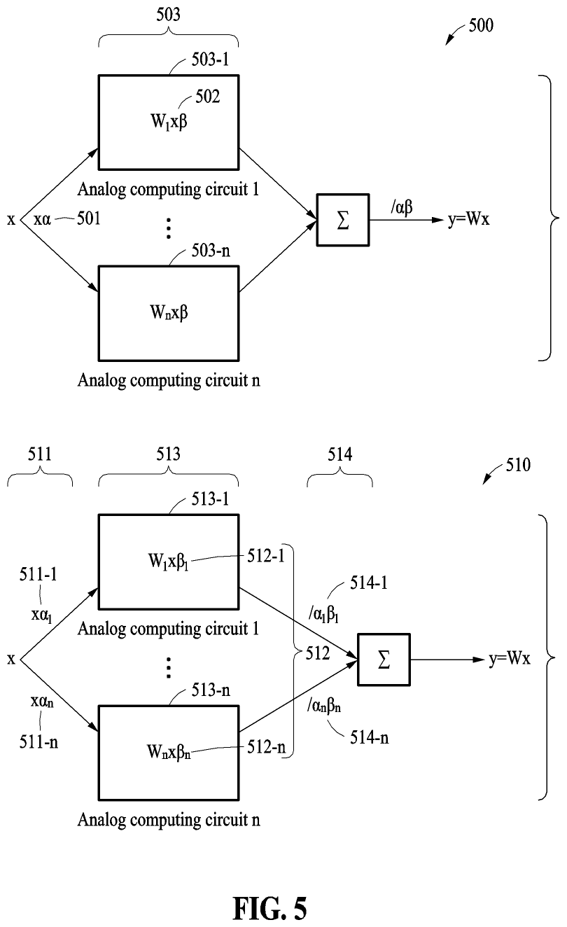

Referring to FIG. 5, operations 500 and 510 in which the size of a machine learning model to be performed is larger than the size of an analog computing circuit or in the case of summing partial sums like a convolution neural network example may be performed by a computing device (e.g., the computing device 130 of FIG. 1).

The magnitudes (e.g., respective negative and/or positive magnitudes, as applicable) of an input x that is input to a plurality of analog computing circuits 503 of the computing device may be scaled by the same input scaling factor 501. Here, the input scaling factor 501 may be a first scaling factor that scales at least some of the magnitudes of the input values of input x to exceed a preset input maximum range of values. Therefore, the magnitudes of the respective input x of analog computing circuit 1 503-1 maybe scaled the same as the input x of analog computing circuit n 503-n. In an example, the same input values of the input x may be input to the plurality of analog computing circuits 503.

Each of the plurality of analog computing circuits 503 may include different weights W1, . . . , Wn (e.g., with each weight W1-Wn being a respective single or multi-dimensional weight values). For example, when the total number of parameters (e.g., weights) of a neural network layer of the machine learning model is larger than the total number of weights that can be stored in a time or time period, in the example resistive elements of a crossbar structure of one analog computing circuit, corresponding to when the respective input values of the input x is provided to the analog computing circuit, the total number of parameters may be divided (or may already be separate or divided as stored) into different weights W1-Wn. As another example, when a convolution operation includes multiple kernels with corresponding weights W1-Wn to be convolved with the input x, an input value of the input x may be multiplied with each of plural weight values among the different weights W1-Wn by the respective analog computing circuit 1 503-1 through n 503-n. In this manner, the analog computing circuit 1 503-1 through n 503-n may operate in parallel.

The magnitudes (e.g., respective negative and/or positive magnitudes, as applicable) of the different weights W1, . . . , Wn in each of the plurality of analog computing circuits 503 may be scaled by the same weight scaling factor 502. Here, the weight scaling factor 502 may be a second scaling factor that scales at least some of the magnitudes of the different weights W1, . . . , Wn to exceed a preset weight maximum range of values. Accordingly, the weight of the analog computing circuit 1 503-1 maybe scaled the same as that of the analog computing circuit n 503-n.

Here, the first scaling factor that is the input scaling factor 501 and the second scaling factor that is the weight scaling factor 502 may be determined by any of the methods described above with reference to FIG. 4, as a non-limiting example.

Each of the plurality of analog computing circuits 503 may perform an operation on the scaled input x and the scaled different weights W1, . . . , Wn. Outputs of the plurality of analog computing circuits 503 may be summed. The summed output of the plurality of analog computing circuits 503 may be rescaled by the input scaling factor 501 and the weight scaling factor 502 and may be determined as a final output. For example, the summed output may be rescaled by dividing the summed output by the input scaling factor 510 and the weight scaling factor 502.

In operation 510, each of a plurality of analog computing circuits 513 may be individually scaled, rescaled, and then summed.

Each input x that is input to the plurality of analog computing circuits 513 may be scaled by an input scaling factor 511. The input scaling factor 511 may include a plurality of first scaling factors (first scaling factor 1 511-1 to first scaling factor n 511-n) that respectively scale magnitudes of the input x to exceed the preset input maximum range of values. Accordingly, the input x of the analog computing circuit 1 513-1 and the input x of the analog computing circuit n 513-n may be scaled differently.

As described above with respect to analog computing circuits 503, each of the plurality of analog computing circuits 513 may include different weights W1, . . . , Wn (e.g., with each weight W1-Wn having respective single or multi-dimensional weight values). The different weights W1, . . . , Wn in each of the plurality of analog computing circuits 513 may be scaled by different weight scaling factors 512. Here, the weight scaling factors 512 may include a plurality of second scaling factors (second scaling factor 1 512-1 to second scaling factor n 512-n) that scales at least some of the magnitudes of the different weights W1, . . . , Wn to exceed the preset weight maximum range of values. Accordingly, the weight W1 of the analog computing circuit 1 513-1 and the weight Wn of the analog computing circuit n 513-n may be scaled differently. In this manner, the analog computing circuit 1 513-1 through n 513-n may operate in parallel.

Here, each of the plurality of first scaling factors in the input scaling factor 511 may be determined by any of the methods described with reference to FIG. 4, as a non-limiting example. Similarly, each of the plurality of second scaling factors in the weight scaling factor 512 may be determined by any of the methods described above with reference to FIG. 4, as a non-limiting example.

Unlike operation 500, operation 510 may first rescale an output of the plurality of analog computing circuits 513 before summing the output. Referring to operation 510, the output of each of the plurality of analog computing circuits 513 may be rescaled using the plurality of first scaling factors 511 and the plurality of second scaling factors 512. The output of an analog computing circuit may be rescaled using the first scaling factor that was used to scale the magnitudes of the input x and the second scaling factor that was used to scale the magnitudes of the weight. For example, the output of the analog computing circuit 1 513-1 may be rescaled using the first scaling factor 1 511-1 and the second scaling factor 1 512-1 (e.g., by dividing the output of the analog computing circuit 1 513-1 by the first scaling factor 1 511-1 and the second scaling factor 1 512-1).

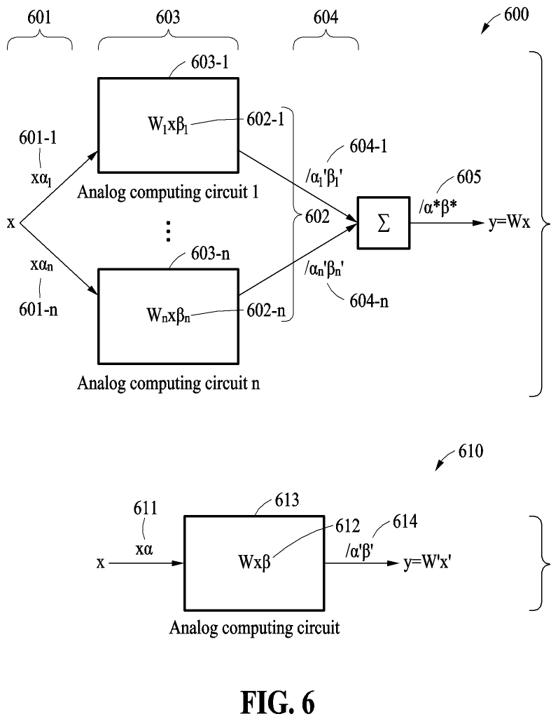

FIG. 6 demonstrates operations 600 and 610, corresponding to when a factor used for scaling and rescaling is different.

Referring to operation 600, each input x that is input to a plurality of analog computing circuits 603 may be scaled by an input scaling factor 601. The input scaling factor 601 may include a plurality of first scaling factors (first scaling factor 1 601-1 to first scaling factor n 601- n) that scales magnitudes of input values of the input x to exceed a preset input maximum range of values. Accordingly, an input of analog computing circuit 1 603-1 and an input of analog computing circuit n 603-n may be scaled differently.

As described above with respect to analog computing circuits 503, each of the plurality of analog computing circuits 603 may include different weights W1, . . . , Wn (e.g., with each weight W1-Wn having respective single or multi-dimensional weight values). The respective magnitudes of the weight values, of the different weights W, in each of the plurality of analog computing circuits 603 may be scaled by different weight scaling factors 602. Here, the weight scaling factor 602 may include a plurality of second scaling factors (second scaling factor 1 602-1 to second scaling factor n 602-n) that scales the respective magnitudes of the weight values of the different weights W1, . . . , Wn to exceed a preset weight maximum range of values. Accordingly, the weight W1 of the analog computing circuit 1 603-1 and the weight Wn of the analog computing circuit n 603-n may be scaled differently.

Here, each of the plurality of first scaling factors in the input scaling factor 601 may be determined by any of the methods described above with reference to FIG. 4, as a non-limiting example. Similarly, each of the plurality of second scaling factors in the weight scaling factor 602 may be determined by any of the methods described above with reference to FIG. 4, as a non-limiting example.

In operation 600, an output of each of the plurality of analog computing circuits 603 may be rescaled using a first rescaling factor 604. The first rescaling factor 604 may include first rescaling factor 1 604-1 to first rescaling factor n 604-n.

An output of the analog computing circuit 1 603-1 maybe rescaled by the first rescaling factor 1 604-1. An output of the analog computing circuit n 603-n may be rescaled by the first rescaling factor n 604-n.

The respective results of the rescaling of the outputs of the analog computing circuit 1 603-1 through n 603-n by the respective first rescaling factors 1 604-1 through n 604-n may be summed, and further rescaled by the second rescaling factor 605, and determined as a final output.

The final output of operation 600 may be the same as that of operation 510. That is, in operation 600, the output of the plurality of analog computing circuits 603 and the summed value may be rescaled using the first rescaling factor 604 and the second rescaling factor 605 that are different from the input scaling factor 601 and the weight scaling factor 602, but the final output may be the same as that of operation 510. That is, in operation 600, the input scaling factor 601 and the weight scaling factor 602 may be divided into the first rescaling factor 604 and the second rescaling factor 605.

The first rescaling factor 604 may be set as 2n and a bit shift operation may be implemented. Alternatively, the input scaling factor 601 may be used as the first scaling factor 604 and may be set as 2n and a bit shift operation may be implemented.

Referring to operation 610, the input x may be scaled using a first scaling factor 611. The weight W may be scaled using a second scaling factor 612. An analog computing circuit 613 may perform an MVM operation using the input x and the weight W respectively scaled by the first scaling factor 611 and the second scaling factor 612. An output of the analog computing circuit 613 may be rescaled using a rescaling factor 614 that is different from the first scaling factor 611 and the second scaling factor 612. Therefore, a result may be different from a case of rescaling the output of the plurality of analog computing circuits 603 using the first scaling factor 611 and the second scaling factor 612. That is, a result of operation 610 may be y=W′x′ that is different from y=Wx. Here, the rescaling factor 614, the first scaling factor 611, and the second scaling factor 612 may be determined by considering a batch normalization operation to be performed next using the output of the analog computing circuit 613.

In the above description with reference to FIGS. 4 to 6, it is described that scaling of the respective magnitudes of the input x and the weight W to respectively exceed the preset input maximum range of values and the preset weight maximum range of values is performed, but the scaling is not limited thereto.

That is, in an example, only one of the scaling of magnitudes of the input x to exceed the preset input maximum range of values and the scaling of magnitudes of the weight W to exceed the preset weight maximum range of values may be performed. For example, in operation 410, only the weight W may be scaled using the second scaling factor 412 and the input x may not be scaled, in which case, a result of the analog computing circuit 413 may be rescaled only using the second scaling factor 412.

In an example, when only a respective one of magnitudes of the input x and magnitudes of the weight W is scaled to exceed the corresponding preset maximum range of values, i.e., the corresponding preset input maximum range of values when magnitudes of the input x is scaled and the corresponding preset weight maximum range of values when magnitudes of the weight W is scaled, the other one (the magnitudes of the weight W or the magnitudes of the input x, different from the respective one) may be increased or decreased to respectively be maximum (normalized) in the other corresponding preset maximum range of values, i.e., maximum positive (and maximum negative if applicable) values may be scaled to be increased or decreased to be at or near the maximum positive (and maximum negative if applicable) values of the other corresponding preset maximum range of values. That is, the other one of the magnitudes of the weight W or the magnitudes of the input x may be scaled using the normalization factor. For example, in operation 410, only the weight W may be scaled using the second scaling factor 412 and the input x may be scaled using only using the normalization factor. Here, a result of the analog computing circuit 413 may be rescaled using the second scaling factor 412 and the normalization factor.

FIG. 7 illustrates example operations of an electronic device, according to one or more embodiments.

Referring to FIG. 7, an operational precision graph 700 demonstrates the scaling factor of the x-axis may be the first scaling factor and/or second scaling factor as described above. The y-axis denotes operational precision.

A first graph 710 shows improvement in operational precision due to an increase in signal-to-noise ratio (SNR). Referring to the first graph 710, as the scaling factor increases, operational precision may increase continuously as shown in the first graph 710 due to the increase in SNR. However, the increasing improvement in operational precision due to the increase in SNR according to the increase in the scaling factor gradually decreases, and accordingly, the first graph 710 may have a form of converging to a specific operational precision value or a form corresponding to a decrease in the rate of increase of the operational precision though still continuing to increase at the decreased rate.

A second graph 720 shows a decrease in operational precision due to clipping. When the scaling factor becomes too large and increased magnitudes of an input and/or increased magnitudes of a weight respectively exceed a respective range of values, the aforementioned clipping may occur, and accordingly, the increased magnitudes of the input and/or the increased magnitudes of the weight may not be properly expressed. Said another way, when the scaling factor increases beyond a certain size, operational precision may decrease due to clipping. Where this clipping occurs and corresponding operation precision of the second graph 720 decreases may denote the normalization factor. Thus, when the scaling factor exceeds such a normalization factor, the corresponding operational precision may begin to decrease due to clipping as shown in the second graph 720.

A third graph 730 may be a graph that aggregates the improvement in operational precision due to the increase in SNR according to the increase in the scaling factor and the decrease in operational precision due to clipping according to the increase in the scaling factor. Referring to the third graph 730, until the scaling factor reaches an optimization factor, the improvement in operational precision (first graph 710) due to the increase in SNR is greater than the decrease in operational precision (second graph 720) due to clipping, and thus the aggregated operational precision may still increase continuously even though clipping is occurring. However, when the scaling factor exceeds an observable/determinable optimization factor, i.e., as the rate of improvement of the SNR decreases, the improvement in operational precision due to the increase in SNR becomes smaller than the decrease in operational precision due to clipping, resulting in the aggregated operational precision beginning to decrease.

Accordingly, referring to FIG. 7, as a total scaling factor is increased beyond the normalization factor toward the observable/determinable optimization factor, the operational precision may increase, and the performance may be better than when the scaling factor is only the normalization factor. Accordingly, the respective optimization factor that is to be applied the input x and the weight W may be determined as this point in the third graph 730 where the maximum aggregate performance is achieved.

The normalization factor may be a factor that increases or decreases an input or a weight to be maximum (normalized) in the corresponding preset maximum range of values, i.e., the magnitudes of the inputs or the magnitudes of the weights are scaled based on a respective normalization factor that correspondingly maximizes the maximum positive (and/or maximum negative if applicable) value with respect to the maximum value of the corresponding preset maximum range of values, based on a respective distribution range of the input or the weight as described above with reference to FIG. 4. That is, each of the first factor and the third factor in FIG. 4 maybe a corresponding normalization factor.

The corresponding optimization factors may also be obtained using the second factor and/or the fourth factor, as described above with respect to FIG. 4, which respectively further increase the respective magnitudes of the already increased (according to the first factor) magnitudes of the input and already increased (according to the third factor) magnitudes of the weight to respectively exceed the preset input maximum range of values and the preset weight maximum range of values. That is, the respective optimization factors for the input x and the weight W may be a first scaling factor obtained by multiplying the first factor and the second factor, and a second scaling factor obtained by multiplying the third factor and the fourth factor in FIG. 4.

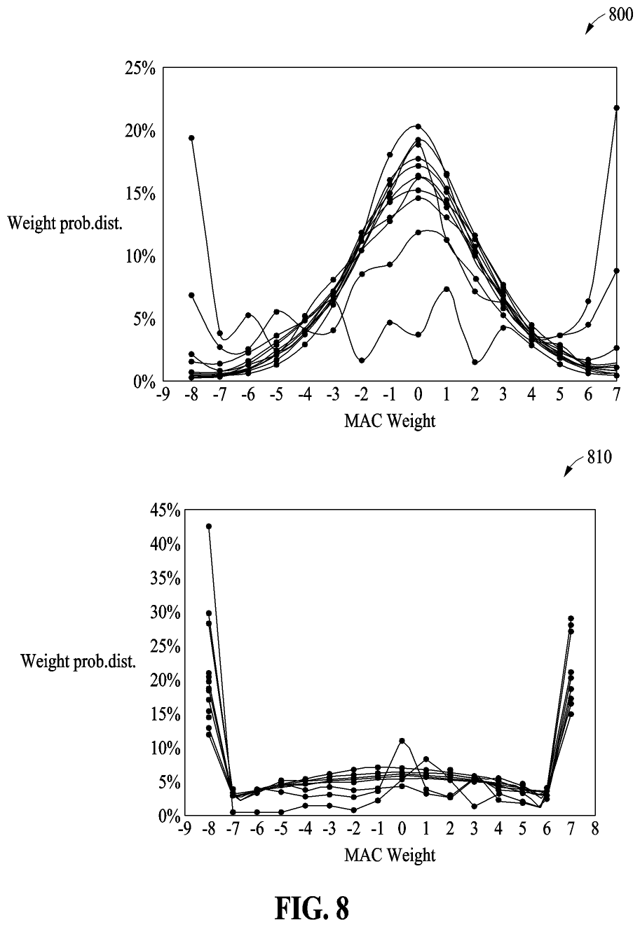

FIG. 8 illustrates example weight value probability distributions according to scaling factors, according to one or more embodiments.

Referring to FIG. 8, a graph 800 shows a distribution of scaled weight values when the weight values are scaled by a normalization factor and a graph 810 shows a distribution of scaled weight values when the weight values are scaled by an optimization factor. Here, as a non-limiting example, a preset weight maximum range of values may be −8 to +7.

Referring to the graph 800, since the weight values are scaled by the normalization factor, the scaled weight values may exist in the range of −8 to +7 of the preset weight maximum range of values.

On the other hand, referring to the graph 810, since the weight values are scaled by the optimization factor, some of the scaled weight values may exceed the preset weight maximum range of values. Values that exceed the preset weight maximum range of values due to the scaling may be clipped, as discussed above. Accordingly, referring to the graph 810, due to this clipping most of the scaled weight values now exist at or near the respective maximum negative and maximum positive values of −8 and +7.

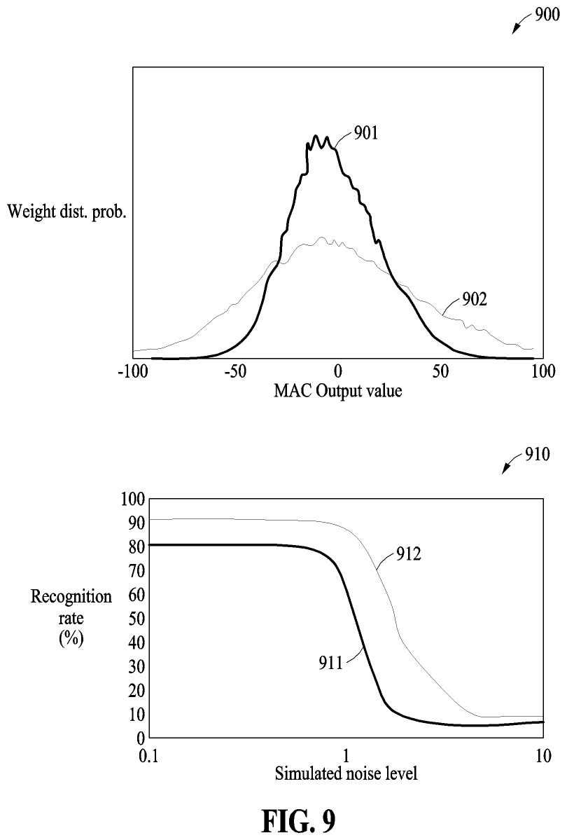

FIG. 9 illustrates an example result of operations performed with a scaling factor, according to one or more embodiments.

Referring to FIG. 9, a graph 900 shows respective distributions of operational output values when a trained weight of a model were scaled according to a normalization factor and an optimization factor, and a graph 910 shows respective recognition rates according to noise.

Referring to the graph 900, a first distribution 901 may represent a distribution of operational results when a weight W was scaled by the normalization factor. According to the first distribution 901, when the weight values of weight W were scaled by the normalization factor, most of the operational results exist in a range of −50 to +50.

On the other hand, a second distribution 902 may represent a distribution of operational results when the weight W was scaled by the optimization factor. According to the second distribution 902, when the weight values of weight W were scaled by the optimization factor, operational results exist in a range of −100 to +100, demonstrating that operation results, based on the weight W being scaled by the optimization factor, exist in a wider range than that of the first distribution 901.

In the graph 910, a first graph 911 may be a graph showing a recognition rate according to noise when the weight W was scaled by the normalization factor. A second graph 912 may be a graph showing a recognition rate according to noise when the weight W was scaled by the optimization factor.

When noise is too large, the recognition rate is low in both cases when the weight is scaled by the normalization factor and when the weight W was scaled by the optimization factor, and thus comparing the first graph 911 with the second graph 912 may be meaningless.

However, noise may occur in a certain range in hardware, and when the noise is not large, as shown in FIG. 7, an SNR gain is greater when scaled by the optimization factor than when scaled by the normalization factor, and thus the second graph 912 may demonstrate a higher recognition rate than that of the first graph 911.

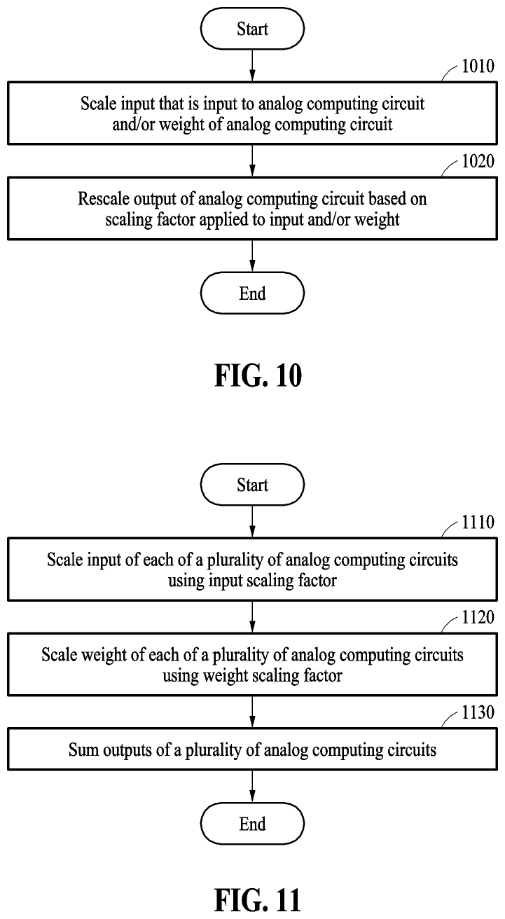

FIGS. 10 to 12 illustrate example methods, according to various embodiments.

In FIG. 10, operations may be performed sequentially, but need not necessarily be performed sequentially. For example, the order of the operations may change and at least two of the operations may be performed in parallel. Operations 1010 and 1020 maybe performed by the electronic device 100. Specifically, the operations of the electronic device 100 may be performed by at least one component (e.g., the computing device 130 of FIG. 1).

In operation 1010, a computing device may scale an input that is input to an analog computing circuit and/or scale a weight of the analog computing circuit.

In operation 1020, the computing device may rescale an output of the analog computing circuit based on scaling factor(s) respectively applied to an input and/or a weight.

Each of the scaling factors applied to an input and/or a weight may be respective factors that scale respective magnitudes of the input and/or the weight to respectively exceed a preset input maximum range of values and/or a preset weight maximum range of values.

In FIG. 11, operations may be performed sequentially, but need not necessarily be performed sequentially. For example, the order of the operations may change and at least two of the operations may be performed in parallel. Operations 1110 to 1130 maybe performed by the electronic device 100. Specifically, the operations of the electronic device 100 may be performed by at least one component (e.g., the computing device 130 of FIG. 1).

In operation 1110, a computing device may scale an input of each of a plurality of analog computing circuits using an input scaling factor.

In operation 1120, the computing device may scale a weight of each of the plurality of analog computing circuits using a weight scaling factor.

In operation 1130, the computing device may sum outputs of the plurality of analog computing circuits.

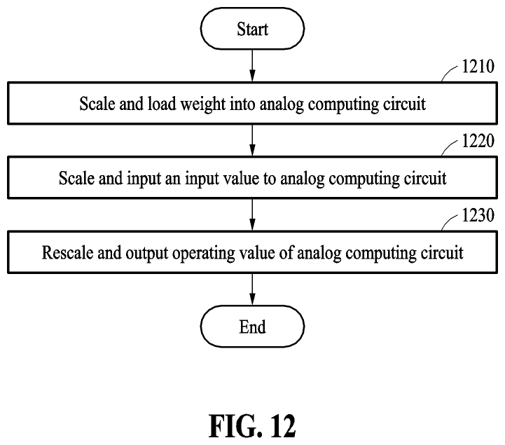

In FIG. 12, operations may be performed sequentially, but need not necessarily be performed sequentially. For example, the order of the operations may change and at least two of the operations may be performed in parallel. Operations 1210 to 1230 maybe performed by the electronic device 100. Specifically, the operations of the electronic device 100 may be performed by at least one component (e.g., the computing device 130 of FIG. 1).

In operation 1210, a computing device may scale and load a weight into an analog computing circuit.

The computing device may load the scaled weight into the analog computing circuit using a second scaling factor that increases the magnitude of the weight to exceed the preset weight maximum range of values. That is, while storing a trained weight value to a resistive element of the analog computing circuit, the computing device may scale the trained weight value so as to store a scaled weight value that is greater than the trained weight value. The resistive element may have different resistances depending on the value of the weight stored to the resistive element, such that in a crossbar array structure a voltage across the resistive element with the scaled weight value will generate a current that can be converted to a digital value by an ADC (e.g., an ADC 250 of FIG. 2). All weight values of a trained weight (e.g., weight W) may be scaled at a same time and then stored to respective resistive elements.

In operation 1220, the computing device may scale and input an input value (e.g., of an input x) to the analog computing circuit. For example, the input x or input value may be provided or obtained from a buffer or memory, at which stage the input x or input value may be scaled, and the scaled input x or input value may be input to the analog computing circuit. In an example, the computing device may input the scaled input through a multiplying of a first scaling factor, which increases magnitudes of the input to exceed the preset input maximum range of values, with the input while inputting input values to the analog computing circuit.

In operation 1230, the computing device may rescale and output an operating value of the analog computing circuit.

The computing device may rescale and output the operating value of the analog computing circuit using the first scaling factor and the second scaling factor.

The electronic devices, computing devices, analog computing circuits, host processors, memories, resistive elements, DACs, ADCs, multiplexer (Mux), and summers described herein, as well as all other devices, circuits, and component descriptions with respect to respect to FIGS. 1-12, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” maybe used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-12 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD−Rs, DVD+Rs, DVD−RWs, DVD+RWs, DVD−RAMs, BD−ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
a computing device comprising an analog computing circuit, wherein the computing device is configured to:
scale an input of the analog computing circuit using a first scaling factor and/or scale a weight of the analog computing circuit using a second scaling factor, where the input includes a plurality of input values within a preset input maximum range of values of the computing device, and the weight includes a plurality of weight values within a preset weight maximum range of values of the computing device; and
rescale an output of the analog computing circuit based on the first scaling factor and/or the second scaling factor, and
wherein the first scaling factor is a factor that scales one or more values of the input to respectively be outside the preset input maximum range of values and the second scaling factor is another factor that scales one or more values of the weight to respectively be outside the preset weight maximum range of values of the computing device.

2. The electronic device of claim 1, wherein the first scaling factor is same as a first input factor multiplied by a second input factor,
wherein the first input factor is a first factor whose application of the first factor to the input scales a maximum input value, of the plurality of input values, to increase to a maximum value of the preset input maximum range of values, and/or that scales a minimum input value, of the plurality of input values, to decrease to a minimum value of the preset input maximum range of values, based on a distribution range of the input, and
wherein the second input factor is a second factor whose application of the second factor to a first scaled input, resulting from the application of the first factor to the input, increases the scaled maximum input value of the first scaled input to be greater than the maximum value of the preset input maximum range of values, and/or that decreases the scaled minimum input value of the first scaled input to be less than the minimum value of the preset input maximum range of values.

3. The electronic device of claim 1, wherein the second scaling factor is same as a third weight factor multiplied by a fourth weight factor,
wherein the third weight factor is a third factor whose application of the third factor to the weight scales a maximum weight value, of the plurality of weight values, to increase to a maximum value of the preset weight maximum range of values, and/or that scales a minimum weight value, of the plurality of weight values, to decrease to a minimum value of the preset weight maximum range of values, and based on a distribution range of the weight, and
wherein the fourth weight factor is a fourth factor whose application of the fourth factor to a first scaled weight, resulting from the application of the third factor to the weight, increases the scaled maximum weight value of the first scaled weight to be greater than the maximum value of the preset weight maximum range of values, and/or that decreases the scaled minimum weight value of the first scaled weight to be less than the minimum value of the preset weight maximum range of values.

4. The electronic device of claim 1, wherein the analog computing circuit has a crossbar array structure comprising resistive elements.

5. The electronic device of claim 1, further comprising:
a host processor configured to control the computing device,
wherein the computing device is disposed inside or outside the host processor.

6. The electronic device of claim 1,
wherein the preset input maximum range of values is same as the preset weight maximum range of values, and
wherein the analog computing circuit is configured to perform analog computations based on the scaled input and the scaled weight to generate the output.

7. The electronic device of claim 1, wherein the computing device comprises a plurality of analog computing circuits, including the analog computing circuit, each respectively arranged in a crossbar array structure with resistive elements configured to store corresponding weight values scaled according to a corresponding second scaling factor, and with each analog computing circuit being provided a respective scaled input according to a corresponding first scaling factor.

8. An electronic device comprising:
a computing device comprising a plurality of analog computing circuits,
wherein the computing device is configured to scale respective inputs of each of the plurality of analog computing circuits using a corresponding input scaling factor, scale respective weights of each of the plurality of analog computing circuits using a corresponding weight scaling factor, and sum respective outputs of the plurality of analog computing circuits.

9. The electronic device of claim 8,
wherein, for each of the analog computing circuits, the corresponding input scaling factor scales positive values of the respective input to increase to become greater than a preset input maximum range of values, and/or scales negative values of the respective input to decrease to become less than the preset input maximum range of values, and
wherein, for each of the analog computing circuits, the corresponding weight scaling factor scales positive values of the respective weight to become greater than a preset weight maximum range of values, and/or scales negative values of the respective weight to decrease to become less than the preset weight maximum range of values.

10. The electronic device of claim 9, wherein the computing device is configured to, for each of the analog computing circuits, scale the respective input using the corresponding input scaling factor, scale the respective weight using the corresponding weight scaling factor, and rescale a result of the summing of the respective outputs of the plurality of computing circuits based on the corresponding input scaling factor and the corresponding weight scaling factor.

11. The electronic device of claim 10,
wherein the corresponding input scaling factors are each same, and
wherein the corresponding weight scaling factors are each same.

12. The electronic device of claim 9,
wherein the preset input maximum range of values is same as the preset weight maximum range of values, and
wherein the analog computing circuits are respectively configured to perform corresponding analog computations based on the respective scaled inputs and the respective scaled weights.

13. The electronic device of claim 8, wherein each of the corresponding input scaling factors are determined for a corresponding one of the respective inputs, and each of the corresponding weight scaling factors are determined for a corresponding one of the respective weights.

14. The electronic device of claim 13, wherein the computing device is configured to, for each of the analog computing circuits, scale the respective input using the corresponding input scaling factor, scale the respective weight using the corresponding weight scaling factor, and rescale the respective output based on the corresponding input scaling factor and the corresponding weight scaling factor, and
wherein the computing device is configured to sum the rescaled respective outputs.

15. The electronic device of claim 8, wherein each of the plurality of analog computing circuits has a crossbar array structure comprising respective resistive elements.

16. The electronic device of claim 8, further comprising:
a host processor configured to control the computing device,
wherein the computing device is disposed inside or outside the host processor.

17. A method of an electronic device including an analog computing circuit, the method comprising:
scaling an input of the analog computing circuit using a first scaling factor and/or scaling a weight of the analog computing circuit using a second scaling factor, where the input includes a plurality of input values within a preset input maximum range of values of the computing device, and the weight includes a plurality of weight values within a preset weight maximum range of values of the computing device; and
rescaling an output of the analog computing circuit based on the first scaling factor and/or the second scaling factor,
wherein the first scaling factor is a factor that scales one or more values of the input to respectively be outside the preset input maximum range of values and the second scaling factor is another factor that scales one or more values of the weight to respectively be outside the preset weight maximum range of values of the computing device.

18. The method of claim 17, wherein the first scaling factor is same as a first input factor multiplied by a second input factor,
wherein the first input factor is a first factor whose application of the first factor to the input scales a maximum input value, of the plurality of input values, to increase to a maximum value of the preset input maximum range of values, and/or that scales a minimum input value, of the plurality of input values, to decrease to a minimum value of the preset input maximum range of values, based on a distribution range of the input, and
wherein the second input factor is a second factor whose application of the second factor to a first scaled input, resulting from the application of the first factor to the input, increases the scaled maximum input value of the first scaled input to be greater than the maximum value of the preset input maximum range of values, and/or that decreases the scaled minimum input value of the first scaled input to be less than the minimum value of the preset input maximum range of values.

19. The method of claim 17, wherein the second scaling factor is same as a third weight factor multiplied by a fourth weight factor,
wherein the third weight factor is a third whose application to the weight scales a maximum weight value, of the plurality of weight values, to increase to a maximum value of the preset weight maximum range of values, and/or that scales a minimum weight value, of the plurality of weight values, to decrease to a minimum value of the preset weight maximum range of values, and based on a distribution range of the weight, and
wherein the fourth weight factor is a fourth factor whose application of the fourth factor to a first scaled weight, resulting from the application of the third factor to the weight, increases the scaled maximum weight value of the first scaled weight to be greater than the maximum value of the preset weight maximum range of values, and/or that decreases the scaled minimum weight value of the first scaled weight to be less than the minimum value of the preset weight maximum range of values.

20. The method of claim 17, wherein the analog computing circuit has a crossbar array structure comprising resistive elements.
